(19) United States
(12) Patent Application Publication
(10) Pub. No.: US 2016/0148265 A1
(43) Pub. Date: May 26, 2016

(54) METHOD FOR PROVIDING ADVERTISEMENT, ELECTRONIC APPARATUS, AND SERVER

(71) Applicant: Samsung Electronics Co., Ltd., Gyeonggi-do (KR)

(72) Inventors: Hyun-Min LIM, Seoul (KR); Hye-Seon SONG, Daejeon (KR)

(73) Assignee: Samsung Electronics Co., Ltd.

(21) Appl. No.: 14/951,017

(22) Filed: Nov. 24, 2015

(30) Foreign Application Priority Data
Nov. 26, 2014 (KR) 10-2014-0166802

(51) Int. Cl. G06Q 30/02; G10L 17/00; G06F 3/16; G10L 15/22

(52) U.S. Cl. CPC G06Q 30/0257; G06Q 30/0269; G10L 15/22; G10L 17/005; G06F 3/167; G10L 2015/223

(57) ABSTRACT

A method and apparatus for providing advertisements are described herein A method includes outputting a banner for a first advertisement, receiving a first voice input that requests the first advertisement, identifying first user information that corresponds to the first voice input, from among user information of a plurality of users, and outputting a first type of advertisement that is selected based on first usage history information that corresponds to the first user information, from among a plurality of types of advertisements that correspond to the first advertisement.

### PRIORITY

This application claims priority under 35 U.S.C. §119(a) to Korean Application Serial No. 10-2014-0166802, which was filed in the Korean Intellectual Property Office on Nov. 26, 2014, the contents of which are incorporated herein by reference.

### BACKGROUND OF THE DISCLOSURE

1. Field of the Disclosure

The present disclosure relates generally to a method for providing advertisements, and more particularly, to a method for providing advertisements according to a user's request for the advertisement.

2. Description of the Related Art

With the increase in use of various electronic apparatuses, such as smart television (TV) sets, smart phones, and tablet personal computers (PCs), advertisements are provided through the electronic apparatuses more than ever. In addition, banner advertisements are now widely used. To do so, the user selects a specific banner advertisement that is displayed in a specific area of the electronic apparatus to then be provided with the advertisement. For example, in a smart TV set, the user moves on to a displayed banner area by using a remote controller, and clicks on the banner by pressing an OK button to then be provided with an advertisement through specified landing pages.

In recent years, the advertisement viewer target to be provided with the advertisement has been configured, and the advertisements customized for the advertisement viewer target have been provided. The targeting technology used in the banner advertisement includes the regional targeting that uses unique information of the electronic apparatus, individual-model targeting, or time targeting. According to the targeting technology, the advertisement may be exposed to viewers of a specific target group, or different landing pages may be transmitted depending on the viewers of the target groups to thereby provide different advertisements.

In order to receive the advertisement through the banner advertisement, the user needs to select a banner through an input means, which is an inconvenience. Furthermore, accessibility to the advertisement through the banner is compromised.

In addition, when the advertisements are targeted depending on viewers who are provided with the advertisement by using unique information of the electronic apparatuses, the electronic apparatuses cannot individually target each of a plurality of users.

### SUMMARY

The present disclosure has been made to address at least the above problems and/or disadvantages and to provide at least the advantages described below. Accordingly, an aspect of the present disclosure provides an apparatus and a method for providing advertisements in a more convenient and accessible manner than in the prior art, such as by a voice input.

In accordance with an aspect of the present disclosure, a method for providing advertisements includes outputting a banner for a first advertisement, receiving a first voice input that requests the first advertisement, identifying first user information that corresponds to the first voice input, from among user information of a plurality of users, and outputting a first type of advertisement that is selected based on first usage history information that corresponds to the first user information, from among a plurality of types of advertisements that correspond to the first advertisement.

In accordance with another aspect of the present disclosure, an electronic device includes a display that outputs a banner for a first advertisement, and a controller that controls to receive a first voice input that requests the first advertisement, to identify first user information that corresponds to the first voice input, from among user information for a plurality of users, and to output a first type of advertisement that is selected based on the first usage history information that corresponds to the first user information, from among a plurality of types of advertisements that correspond to the first advertisement.

In accordance with another aspect of the present disclosure, a method of a server that provides advertisements to an electronic device includes receiving a request for a first advertisement from a first voice input received in the electronic device, receiving first usage history information that corresponds to first user information that is identified through the first voice input, selecting a first type of advertisement from among a plurality of types of advertisements that correspond to the first advertisement, based on the first usage history information, and outputting the first type of advertisement.

In accordance with another aspect of the present disclosure, a server for providing advertisements toan electronic apparatus includes a communication module that receives a request for the first advertisement from a first voice input received from the electronic device, and receives first usage history information that corresponds to first user information that is identified through the first voice input, and a controller that selects a first type of advertisement from among a plurality of types of advertisements that correspond to the first advertisement, based on the first usage history information, and outputs the first type of advertisement through the communication module.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 illustrates a network environment including an electronic apparatus, according to an embodiment of the present disclosure;

FIG. 2 illustrates a program module, according to an embodiment of the present disclosure;

FIG. 3 illustrates an advertisement providing method, according to an embodiment of the present disclosure;

FIG. 4 illustrates an advertisement providing module of an electronic apparatus, according to an embodiment of the present disclosure;

FIG. 5 illustrates a server, according to an embodiment of the present disclosure;

FIG. 6 illustrates an advertisement providing method by an electronic apparatus and a server, according to an embodiment of the present disclosure;

FIG. 7 illustrates an advertisement providing method by an electronic apparatus, according to an embodiment of the present disclosure;

FIG. 8 illustrates a banner for the advertisement, according to an embodiment of the present disclosure;

FIG. 9A is a conceptual diagram showing the relationship between user information and usage history information of a plurality of users, according to an embodiment of the present disclosure;

FIG. 9B is a conceptual diagram of usage history information, according to an embodiment of the present disclosure;

FIG. 10A illustrates a plurality of types of advertisements corresponding to the first advertisement, according to an embodiment of the present disclosure;

FIG. 10B illustrates a plurality of types of advertisements corresponding to the first advertisement, according to an embodiment of the present disclosure;

FIG. 11 illustrates a plurality of types of advertisements corresponding to the first advertisement, according to an embodiment of the present disclosure;

FIG. 12 illustrates an electronic apparatus that outputs a banner for the second advertisement that is selected to be related to the first advertisement, according to an embodiment of the present disclosure;

FIG. 13 illustrates an electronic apparatus that outputs a plurality of banner advertisements that are selected based on usage history information, according to an embodiment of the present disclosure;

FIG. 14 illustrates an operating method of a server, according to an embodiment of the present disclosure;

FIG. 15 illustrates a method for selecting the first type of advertisement, according to an embodiment of the present disclosure;

FIG. 16 illustrates a method for providing the second advertisement that is related to the first advertisement, according to an embodiment of the present disclosure; and

FIG. 17 illustrates an electronic apparatus, according to an embodiment of the present disclosure.

### DETAILED DESCRIPTION OF EMBODIMENTS OF THE DISCLOSURE

Hereinafter, embodiments of the present disclosure will be described with reference to the accompanying drawings. However, it should be understood that there is no intent to limit the present disclosure to the particular forms disclosed herein; rather, the present disclosure should be construed to cover various modifications, equivalents, and/or alternatives of embodiments of the present disclosure. In describing the drawings, similar reference numerals may be used to designate similar constituent elements. Descriptions of well known functions and configurations are omitted for the sake of clarity and conciseness.

As used herein, the expression “have”, “may have”, “include”, or “may include” refers to the existence of a corresponding feature such as numeral, function, operation, or constituent element such as component, and does not exclude one or more additional features.

As used herein, the expression “A or B”, “at least one of A or/and B”, or “one or more of A or/and B” may include all possible combinations of the items listed. For example, the expression “A or B”, “at least one of A and B”, or “at least one of A or B” refers to all of (1) including at least one A, (2) including at least one B, or (3) including all of at least one A and at least one B.

The expression “a first”, “a second”, “the first”, or “the second” used in embodiments of the present disclosure may modify various components regardless of the order and/or the importance but does not limit the corresponding components. The above expressions are used merely for the purpose of distinguishing an element from the other elements. For example, a first user device and a second user device indicate different user devices although both of them are user devices. For example, a first element may be termed a second element, and similarly, a second element may be termed a first element without departing from the scope of the present disclosure.

It should be understood that when an element such as a first element is referred to as being operatively or communicatively “connected,” or “coupled,” to another element such as a second element, the first element may be directly connected or coupled directly to the other element or any other element such as third element may be interposer between them. In contrast, it may be understood that when the first element is referred to as being “directly connected,” or “directly coupled” to the second element, there is no third element interposed between the first and second elements.

The expression “configured to” used in the present disclosure may be exchanged with, for example, “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may mean that the device, together with other devices or components, “is able to”. For example, the phrase “processor adapted (or configured) to perform A, B, and C” may indicate a dedicated processor (e.g. embedded processor) only for performing the corresponding operations or a generic-purpose processor such as central processing unit (CPU) or application processor (AP) that can perform the corresponding operations by executing one or more software programs stored in a memory device.

The terms used herein are merely for the purpose of describing particular embodiments and are not intended to limit the scope of other embodiments. As used herein, singular forms include plural forms as well unless the context clearly indicates otherwise. Unless defined otherwise, all terms used herein, including technical and scientific terms, have the same meaning as those commonly understood by a person skilled in the art to which the present disclosure pertains. Such terms as those defined in a generally used dictionary are to be interpreted to have the meanings equal to the contextual meanings in the relevant field of the art, and are not to be interpreted to have ideal or excessively formal meanings unless clearly defined in the present disclosure. In some cases, even the term defined in the present disclosure should not be interpreted to exclude embodiments of the present disclosure.

An electronic device according to embodiments of the present disclosure may include at least one of a smartphone, a tablet personal computer (PC), a mobile phone, a video phone, an electronic book (e-book) reader, a desktop PC, a laptop PC, a netbook computer, a personal digital assistant (PDA), a portable multimedia player (PMP), an MP3 player, a mobile medical appliance, a camera, and a wearable device such as a head-mounted-device (HMD) including electronic glasses, electronic clothes, an electronic bracelet, an electronic necklace, an electronic appcessory, electronic tattoos, and a smart watch.

According to some embodiments, the electronic device may be a smart home appliance. The home appliance includes at least one of, for example, a television, a digital video disk (DVD) player, an audio, a refrigerator, an air conditioner, a vacuum cleaner, an oven, a microwave oven, a washing machine, an air cleaner, a set-top box, a home automation control panel, a security control panel, a TV box such as Samsung HomeSync™, Apple TV™, or Google TV™, a game console such as Xbox™ and PlayStation™, an electronic dictionary, an electronic key, a camcorder, and an electronic photo frame.

According to another embodiment, the electronic device includes at least one of various medical devices such as a blood glucose monitoring device, a heart rate monitoring device, a blood pressure measuring device, and a body temperature measuring device, a magnetic resonance angiography (MRA) device, a magnetic resonance imaging (MRI) device, a computed tomography (CT) machine, and an ultrasonic machine, a navigation device, a global positioning system (GPS) receiver, an event data recorder (EDR), a flight data recorder (FDR), a vehicle infotainment device, an electronic devices for a ship such as a navigation device for a ship, and a gyro-compass, avionics, security devices, an automotive head unit, a robot for home or industry, an automatic teller's machine (ATM), point of sales (POS) in a shop, or Internet of things device such as a light bulb, various sensors, electric or gas meter, a sprinkler device, a fire alarm, a thermostat, a streetlamp, a toaster, a sporting goods, a hot water tank, a heater, and a boiler.

According to some embodiments, the electronic device includes at least one of a part of furniture or a building/structure, an electronic board, an electronic signature receiving device, a projector, and various types of measuring instruments such as a water meter, an electric meter, a gas meter, and a radio wave meter. The electronic device according to embodiments of the present disclosure may be a combination of one or more of the aforementioned various devices. The electronic device according to some embodiments of the present disclosure may be a flexible device. The electronic device according to an embodiment of the present disclosure is not limited to the aforementioned devices, and may include a new electronic device according to the development of technology.

Hereinafter, an electronic device according to embodiments will be described with reference to the accompanying drawings. As used herein, the term “user” indicates a person who uses an electronic device or a device such as an artificial intelligence electronic device that uses an electronic device.

According to embodiments of the present disclosure, the user is conveniently provided with the banner advertisement through a voice input. In addition, the electronic apparatus provides a type of advertisement that is selected based on the voice input so that the electronic apparatus can individually target each of a plurality of users to then provide the advertisement.

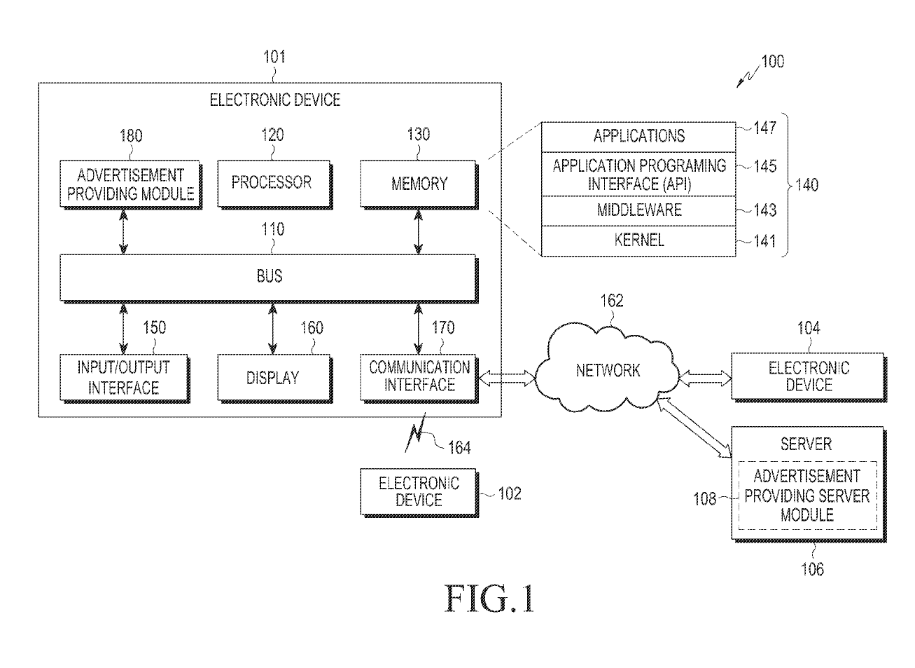

Referring to FIG. 1, an electronic device 101 within a network environment 100 according to an embodiment of the present disclosure is described. The electronic device 101 includes a bus 110, a processor 120, a memory 130, an input/output interface 150, a display 160, a communication interface 170, and an advertisement providing module 180. At least some of the above elements may be omitted from the electronic device 101 or other elements may be added to the electronic device 101.

The bus 110 includes a circuit for connecting the elements 120 to 180 and transmitting communications between the elements.

The processor 120 includes one or more of a central processing unit (CPU), an application processor (AP), and a communication processor (CP). The processor 120 executes, for example, an operation or data processing for the control of and/or communication between one or more other element of the electronic device 101. The processor 120 is referred to as a controller or includes a controller as a component.

The memory 130 includes a volatile memory and/or a non-volatile memory. The memory 130 may store, for example, instructions or data related to at least one other element of the electronic device 101. According to an embodiment, the memory 130 may store software and/or a program 140. The program 140 includes a kernel 141, middleware 143, an application programming interface (API) 145, and/or an application program (or “applications”) 147. At least some of the kernel 141, the middle 143, and the API 145 may be referred to as an Operating System (OS).

For example, the kernel 141 controls or manages system resources which are used to execute an operation or a function implemented in the other programs such as the middleware 143, the API 145, and the application programs 147. The kernel 141 provides an interface through which the middleware 143, the API 145, or the application program 147 may access individual elements of the electronic device 101 to control or manage system resources.

The middleware 143 serves as a relay for allowing the API 145 or the application programs 147 to communicate with the kernel 141 to exchange data. In regard to task requests received from the application program 147, the middleware 143 performs a control such as scheduling or load balancing for the task requests using, for example, a method of assigning at least one application a priority for using the system resources.

The API 145 is an interface by which the applications 147 control functions provided from the kernel 141 or the middleware 143, and includes, for example, at least one interface or function for file control, window control, image processing, or text control.

As used herein, the applications may be referred to as an application program.

The input/output interface 150 serves as an interface which can transmit commands or data input from the user or another external device to other element(s) of the electronic device 101. The input/output interface 150 outputs commands or data received from another element(s) of the electronic device 101 to the user or another external device.

The display 160 includes, for example, a liquid crystal display (LCD), a light emitting diode (LED) display, an organic light emitting diode (OLED) display, a micro electro mechanical system (MEMS) display, or an electronic paper display. The display 160 displays various types of contents such as text, images, videos, icons, or symbols for users. The display 160 includes a touch screen and receives, for example, a touch input, a gesture input, a proximity input, or a hovering input using an electronic pen or a user's body part.

The communication interface 170 configures communication between, for example, the electronic device 101 and an external device such as a first external electronic device 102, a second external electronic device 104, or a server 106. The communication interface 170 may be connected to a network 162 through wireless or wired communication to communicate with the external device.

The first external electronic device 102 may be, for example, a beacon, and transmits/receives a beacon signal 164 at preset time intervals and based on various communication protocols such as Bluetooth®, WiFi, and ANT.

The wireless communication uses, for example, at least one of long term evolution (LTE), LTE-advanced (LTE-A), code division multiple access (CDMA), wideband CDMA (WCDMA), universal mobile telecommunication service (UMTS), wireless broadband (WiBro), and global system for mobile communications (GSM), for example, as a cellular communication protocol. The wired communication includes, for example, at least one of a universal serial bus (USB), a high definition multimedia interface (HDMI), recommended standard 232 (RS-232), and a plain old telephone service (POTS). The network 162 includes at least one of communication networks such as a computer network including a local area network (LAN) or a wide area network (WAN), the Internet, and a telephone network.

Each of the first and second external electronic devices 102 and 104 may be the same as or different from the electronic device 101. According to an embodiment, the server 106 includes one or more servers. According to embodiments, all or some of the operations performed by the electronic device 101 may be performed by another electronic device or a plurality of electronic devices.

When the electronic device 101 should perform some functions or services automatically or by request, the electronic device 101 makes a request for performing at least some of the functions related to the functions or services to another device instead of performing the functions or services by itself. The other electronic device performs the requested function or the additional function and transfer the result, obtained by carrying out the function, to the electronic device 101. The electronic device 101 provides the requested functions or services based on the received result as it is or after additionally processing the received result. To achieve this, for example, cloud computing, distributed computing, or client-server computing technology may be used.

The advertisement providing module 180 supports driving of the electronic device 101 by performing at least one of the operations implemented by the electronic device 101. For example, the server 106 includes the advertisement providing module 108 capable of supporting the advertisement providing module 180 implemented in the electronic device 101. The advertisement providing server module 108 includes one or more elements of the service providing module 180 and performs at least one of operations of the advertisement providing module 180.

The advertisement providing module 180 processes at least some of the information obtained from other elements of the network environment 100 and utilizes the information in various manners. For example, the advertisement providing module 180 controls at least some functions of the electronic device 101 by using the processor 120 or independently therefrom so that the electronic device 101 may interwork with other electronic devices. The advertisement providing module 180 may be integrated into the processor 120 or the communication interface 170. According to an embodiment, at least one element of the advertisement providing module 180 is included in the server 106 and receives supporting of at least one operation implemented by the advertisement providing module 180 from the server 106.

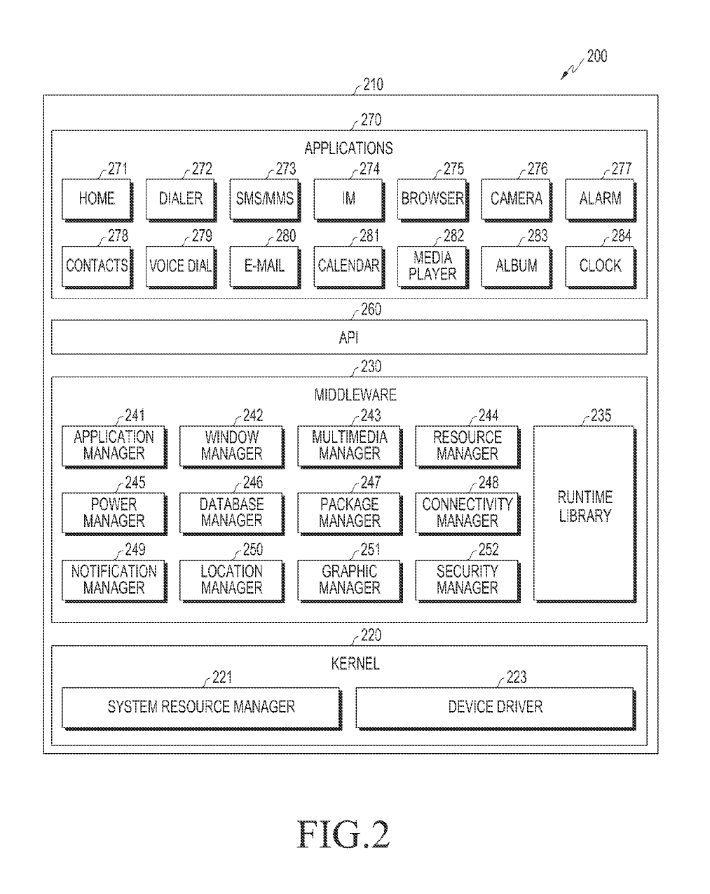

FIG. 2 is a block diagram 200 of a program module 210 according to an embodiment of the present disclosure. Referring to FIG. 2 the program module 210 includes an operating system (OS) for controlling resources related to the electronic device and/or various applications executed in the operating system. The operating system may be, for example, Android, iOS, Windows, Symbian, Tizen, or Bada.

The program module 210 includes a kernel 220, middleware 230, an application programming interface (API) 260, and/or applications 270. At least some of the program module 210 may be preloaded in the electronic device or downloaded in the server.

The kernel 220 includes, for example, a system resource manager 221 or a device driver 223. The system resource manager 221 controls, allocates, or collects the system resources. According to an embodiment, the system resource manager 221 includes a process manager, a memory manager, or a file system manager. The device driver 223 includes, for example, a display driver, a camera driver, a Bluetooth® driver, a shared-memory driver, a universal serial bus (USB) driver, a keypad driver, a WiFi driver, an audio driver, or an inter-process communication (IPC) driver.

The middleware 230 provides a function required by the applications 270 in common or provides various functions to the applications 270 through the API 260 so that the applications 270 may efficiently use limited system resources of the electronic device. According to an embodiment, the middleware 230 includes at least one of a runtime library 235, an application manager 241, a window manager 242, a multimedia manager 243, a resource manager 244, a power manager 245, a database manager 246, a package manager 247, a connectivity manager 248, a notification manager 249, a location manager 250, a graphic manager 251, and a security manager 252.

The run time library 235 includes, for example, a library module that a compiler uses in order to add new functions through a programming language while the application 270 is executed. The run time library 235 performs input/output management, memory management, or an arithmetic function.

The application manager 241 manages a life cycle of at least one application among the applications 270. The window manager 242 manages a graphic user interface (GUI) resource used in a screen. The multimedia manager 243 detects a format required for reproducing various media files and encodes or decodes a media file using a codec appropriate for the corresponding format. The resource manager 244 manages resources such as a source code, a memory or a storage space of at least one application among the applications 270.

The power manager 245 operates together with, for example, a basic input/output system (BIOS), so as to manage a battery or power and provides power information required for the operation of the electronic device. The database manager 246 generates, searches for, or changes a database to be used by at least one of the applications 270. The package manager 247 manages the installation or updating of applications distributed in the form of a package file.

For example, the connectivity manager 248 manages wireless connections, such as WiFi or Bluetooth®. The notification manager 249 displays or notifies an event such as a received message, an appointment, or a proximity notification to a user without disturbance. The location manager 250 manages location information of the electronic device. The graphic manager 251 manages graphic effects to be provided to a user and user interfaces related to the graphic effects. The security manager 252 provides various security functions required for system security or user authentication. According to an embodiment, when the electronic device has a call function, the middleware 230 may further include a telephony manager for managing a voice call function or a video call function of the electronic device.

The middleware 230 includes a middleware module for forming a combination of various functions of the aforementioned elements. The middleware 230 provides a module specialized for each type of operating system in order to provide a differentiated function. In addition, a few existing elements may be dynamically removed from the middleware 230, or new elements may be added to the middleware 230.

The API 260, which is a set of API programming functions, may be provided in a different configuration for each operating system. For example, in Android or iOS, one API set may be provided for each platform, and in Tizen, two or more API sets may be provided for each platform.

The applications 270 include one or more of a home 271, dialer 272, short messaging service/multimedia messaging service (SMS/MMS) 273, instant message (IM) 274, browser 275, camera 276, alarm 277, contact information 278, voice dial 279, e-mail 280, calendar 281, media player 282, album 283, and clock 284 applications. In addition, a health care application such as for measuring an amount of exercise or blood sugar, and an environmental information application such as for providing atmospheric pressure, humidity, or temperature information may be provided.

According to an embodiment, the applications 270 include an information exchange application supporting information exchange between the electronic device and an external electronic device. The information exchange application includes, for example, a notification relay application for transmitting predetermined information to the external electronic device, or a device management application for managing the external electronic device.

For example, the notification relay application includes a function of transferring, to the external electronic device, notification information generated from other applications of the electronic device 101 such as an SMS/MMS) application, an e-mail application, a health management application, or an environmental information application. The notification relay application receives notification information from an external electronic device and provides the received notification information to a user. The device management application manages a function for at least a part of the external electronic device communicating with the electronic device, applications executed in the external electronic device, or services such as telephone call or messaging provided from the external electronic device.

According to an embodiment, the applications 270 include a health management application designated according to attributes of the external electronic device. According to an embodiment, the applications 270 include an application received from the external electronic device such as the server 106 or the electronic device 102 or 104. According to an embodiment, the applications 270 include a preloaded application or a third party application which can be downloaded from the server. Names of the elements of the program module 210, according to the above-described embodiments of the present disclosure, may change depending on the type of OS.

Alternatively, at least some of the program module 210 may be implemented in software, firmware, hardware, or a combination of two or more thereof. At least some of the programming module 210 may be executed by, for example, the AP 210. At least part of the programming module 210 includes, for example, a module, program, routine, sets of instructions, or a process for performing one or more functions.

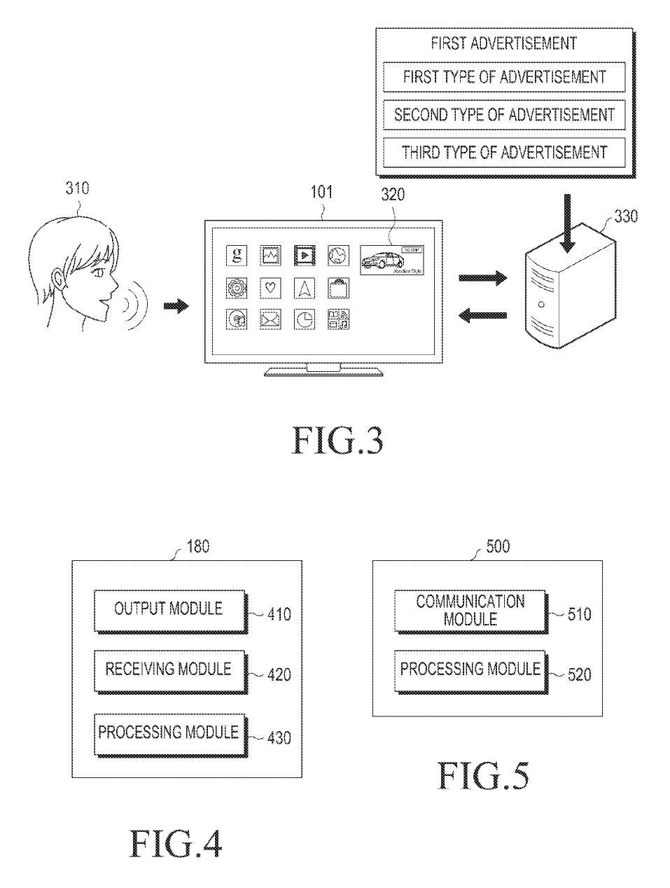

FIG. 3 illustrates an advertisement providing method, according to an embodiment of the present disclosure.

The electronic device 101 receives a voice input from the user 310 device 101 through a microphone, and recognizes the voice input through a voice recognition module. The electronic device 101 performs instructions that correspond to the recognized voice input.

The electronic device 101 receives a banner advertisement from a server 330, and outputs the banner advertisement on a display. The position of the banner 320 where the banner advertisement is displayed and the size of the banner 320 may be pre-configured according to the size of the banner advertisement that is received from the server 330.

If the instruction corresponding to the voice input received from the user 310 requests the advertisement corresponding to the banner advertisement to be displayed on the banner 320 or an instruction for selecting the banner advertisement, the electronic device 101 makes a request to the server 330 for the advertisement corresponding to the banner advertisement. As described above, the electronic device 101 makes a request to the server 330 for the advertisement corresponding to the banner advertisement to be displayed on the banner 320 through the voice input received from the user 310. Accordingly, the user 310 is conveniently provided with the advertisement through the banner 320.

The server 330 includes various types of advertisements for goods or services, which are targeted with a variety of advertisements. In order to provide an advertisement that is customized for the user, the advertiser produces various types of advertisements for goods or services of the advertisement targets. The server 330 includes all of the advertisements that are produced in various types and types for goods or services of the advertisement targets.

For example, the server 330 includes various types of advertisements, such as banner advertisements, image advertisements, video advertisements, or audio advertisements, for the first object that is an advertisement target. In addition, the server 330 includes all of the advertisements that are produced in various types according to each advertisement type. For example, the server 330 includes video advertisements that are produced in a variety of types for the first object.

The various types of advertisements for the first object may be produced in consideration of dispositions, interests, lifetypes, or life patterns of the users who are to be provided with the advertisements. The advertiser classifies dispositions, interests, lifetypes, or life patterns of the users to be provided with the advertisement according to a predetermined reference, and produces various advertisements to correspond to the classified dispositions, interests, lifetypes, or life patterns.

The electronic device 101 identifies user information based on the voice input received from the user 310 device 101, identifies the first user information corresponding to the voice input among the information of a plurality of users of the electronic device 101 device 101, and transmits the first usage history information corresponding to the first user information to the server 330. The first usage history information may be used for selecting the advertisement that is suitable for the user 310 among various types and various types of advertisements that are stored in the server 330. The operation of identifying the first user information corresponding to the voice input will be described later herein.

In addition, the server 330 includes the advertisements such that the objects or the services of the advertisement target are paired with the advertisements that are produced in various types and various types. Accordingly, the server selects and provides the advertisement that is suitable for the user who requests the advertisement.

The server 330 includes various types of advertisements that correspond to the first advertisement that is requested or selected by the electronic apparatus. The various types of advertisements may have the same advertisement target as the first advertisement, and may be different from the first advertisement in its type. For example, when the first advertisement is the banner advertisement to be displayed on the banner 320, the various types of advertisements may be video, image, and audio advertisements.

In addition, the various types of advertisements may have the same or different advertisement target type as the first advertisement. When the first advertisement is the banner advertisement to be displayed on the banner 320, the various types of advertisements may have the same advertisement target as the first advertisement, but be produced in different types from the first advertisement.

As described above, the server 330 may be of various types and includes various types of advertisements that are provided from the advertiser, and selects a proper advertisement based on at least one piece of usage history, age, or gender information of the user who has provided the voice input. In addition, as described above, the various types of advertisements for the first object may be produced to correspond to dispositions, interests, lifetypes, or life patterns of the users who are to be provided with the advertisements. In this case, based on the received usage history information, the server 330 determines a disposition, an interest, a lifetype, or a life pattern of the user who has provided the voice input according to a predetermined reference.

Accordingly, the server 330 selects a type of advertisement corresponding to the determined disposition, interest, lifetype, or life pattern as the advertisement to be provided to the user. The server 330 sends the selected advertisement to the electronic device 101. In addition, selecting the advertisement according to the user among various types of and various types of advertisements for the first object may be conducted by the electronic device 101. A method for selecting the advertisement according to the user will be described in detail later herein.

The electronic device 101 receives the advertisement that has been selected according to the user 310 from the server 330, and outputs the advertisement to a display of the electronic device 101.

As described above, the electronic device 101 identifies the user information according to the voice input of the user 310, and outputs the advertisement that is selected based on at least one piece of the usage history, age, or gender information according to the identified user information. Accordingly, the electronic device 101 conveniently provides a proper advertisement to the user only by the voice input received from the user 310.

FIG. 4 illustrates an advertisement providing module, according to an embodiment of the present disclosure.

Referring to FIG. 4, an advertisement providing module 180 includes at least some or all of an output module 410, a receiving module 420, and a processing module 430. The advertisement providing module 180 may be provided separately from a processor, or at least part of the module may be integrated with the processor.

According to embodiments of the present disclosure, the output module 410 outputs advertisements such as banner, video, audio, or image advertisements on the display of the electronic apparatus. For example, the output module 410 outputs a banner for the first advertisement on the display, and controls to display the first advertisement on the display through a predetermined banner. The first advertisement may be the banner advertisement or another type of advertisement. If the first advertisement is not the banner advertisement, the output module 410 adjusts the size or the resolution of the first advertisement based on the size of the predetermined banner, and outputs the first advertisement through the banner.

The receiving module 420 receives the first voice input that requests the first advertisement from the user through the input/output interface 150. The processing module 430 controls to transmit, to the server 500, the request for the first advertisement through the communication module 170 according to the first voice input. In addition, the receiving module 420 forwards the first voice input to the processing module 430 so that the user information corresponding to the first voice input may be identified.

The processing module 430 identifies the first user information corresponding to the first voice input among the information on a plurality of users. The user information corresponding to each of a plurality of users who use the electronic device 101 is stored in the memory 130 of the electronic device 101. The user information includes at least one piece of the unique voice information of each user, such as a frequency, a waveform, or an amplitude of a user's voice, or the age information and the gender information, which are extracted from the user's voice. In addition, the processing module 430 transmits the first usage history information corresponding to the identified first user information to the server 500 through the communication module 170.

The usage history information is stored in the memory 130 to correspond to each piece of user information for the plurality of users. The usage history information may be used to select a type of advertisement suitable for the user who has provided the first voice input from among a plurality of types of advertisements corresponding to the first advertisement.

The output module 410 outputs, on the display 160, the first type of advertisement that is selected from among a plurality of types of advertisements corresponding to the first advertisement, based on the first usage history information corresponding to the first user information. The output module 410 outputs the first type of advertisement that is received from the server 500 on the display 160. The output module 410 outputs the first type of advertisement through the part of or the entire area of the display.

In an embodiment, the plurality of types of advertisements corresponding to the first advertisement may be produced to be different from each other based on at least one of a category to which the content belongs, the age information, or the gender information. By producing the plurality of types of advertisements corresponding to the first advertisement to be different from each other, the advertisement may be selected according to the user's disposition, interest, lifetype, or life pattern, to then be provided.

The category of the content may be separated according to the type of content such as sports, music, documentary, or drama content, or the type of application for using the content such as social network service (SNS), media, and gaming applications. The type of content and the type of application may be separated in more detail to thereby configure the category of the content, which may be variously configured according to a predetermined reference to provide an advertisement customized for the user.

As described above, the plurality of types of advertisements may be produced based on the category of the content, so it is possible to select a type of advertisement that is customized for the user based on the usage history information that includes the information on the content that the user has used through the electronic device 101.

The plurality of types of advertisement may be produced based on the age or gender information. Various types of advertisements may be produced in consideration of a difference in interests according to age or gender. Furthermore, the plurality of types of advertisements may be produced by considering all of the categories of the content, and the age and gender information, or by a selective combination thereof. The detailed method of selecting the advertisement will be described later herein.

For example a type of advertisement that corresponds to the category of the content that is most frequently used, which is determined based on the first usage history information, is selected as the first type of advertisement displayed through the output module 410. The user's disposition, interest, lifetype, or life pattern may be determined through the content that is most frequently used by the user. Therefore, the first type of advertisement is selected as corresponding to the category of the most frequently used content in order to thereby provide a more customized type of advertisement to the user.

As another example, if there are a plurality of types of advertisements corresponding to the category of the most frequently used content, the first type of advertisement to be displayed through the output module 410 is selected based on the age and gender information, which are contained in the first user information. If there are a plurality of types of advertisements corresponding to the category of the most frequently used content, an additional reference to select the first type of advertisement may be required. In this case, the first type of advertisement is selected based on at least one piece of the age information or the gender information contained in the first user information, so that the user may be provided with a more proper type of advertisement. Since the general dispositions, interests, or lifetypes may be reflected according to age or gender, this information may be used for the additional reference to select the first type of advertisement.

In an embodiment, the first voice input received through the receiving module 420 corresponds to the advertisement request text for the first advertisement displayed on the banner. In order to indicate that the first voice input is a request for the first advertisement, the first voice input corresponds to the advertisement request text that is displayed on the banner. For example, when the advertisement request text “AD Start” is displayed on the banner, the user directs the first voice input of speech “AD Start” into the electronic device 101. Accordingly, the electronic device 101 recognizes that the received first voice input is a request for the first advertisement displayed on the banner.

According to an embodiment, the processing module 430 compares the first voice input with the user's voice characteristics, i.e., at least one of a frequency, waveform, or an amplitude of the user's voice, which corresponds to each piece of user information of a plurality of users, in order to thereby recognize the first user information. The user's voice may be distinct according to at least one of a frequency, waveform, and amplitude of the voice input. Therefore, the processing module 430 identifies the first user information corresponding to the first voice input by comparing the first voice input with at least one of a frequency, waveform, or amplitude of the user's voice corresponding to each piece of user information.

If the first user information corresponding to the first voice input is not identified, the first type of advertisement to be displayed through the output module 410 is selected based on at least one of the age and gender information, which are extracted from the first voice input. If the first voice input is received from the user who has never used the electronic device 101 before, the user information on the user may not be stored in the electronic device 101. In this case, since the first user information corresponding to the first voice input may not be identified, the first type of advertisement is selected based on at least one of the age and gender information, which are extracted from the first voice input.

In an embodiment, the output module 410 outputs a banner for one or more second advertisements that are selected to be related to the first advertisement based on the first usage history information. The second advertisement may be for the second advertisement target that is not the same as, but is similar to the first advertisement target. The output module 410 outputs the second advertisement for the second advertisement target that is similar or related to the first advertisement target to then additionally provide the advertisements for various advertisement targets related to the user's disposition, interest, lifetype, or life pattern.

FIG. 5 illustrates a server, according to an embodiment of the present disclosure.

Referring to FIG. 5, the server 500 includes a communication module 510 and a processing module 520.

The communication module 510 receives a request for the first advertisement by the first voice input received in the electronic device 101. In addition, the communication module 510 receives the first usage history information corresponding to the first user information that is identified through the first voice input. The first usage history information may be used to select an advertisement suitable for the user who has provided the first voice input from among a plurality of types of advertisements corresponding to the first advertisement.

The processing module 520 selects the first type of advertisement from a plurality of types of advertisements corresponding to the first advertisement, based on the first usage history information. The processing module 520 selects the first type of advertisement that is customized for the user who has provided the first voice input from among a plurality of types of advertisements corresponding to the first advertisement, based on the first usage history information. The detailed method of selecting the first type of advertisement will be described later herein.

The communication module 510 transmits the first type of advertisement that is selected in the processing module 520 to the electronic device 101.

For example, the plurality of types of advertisements corresponding to the first advertisement may be produced to be different from each other, based on at least one of the categories of the content, age, and gender information. By producing the plurality of types of advertisements corresponding to the first advertisement to be different from each other, it is possible to provide the advertisement that is selected in consideration of the user's disposition, interest, lifetype, or life pattern.

In an embodiment, the processing module 520 determines the content that is most frequently used based on the first usage history information that is received through the communication module 510, and selects the advertisement corresponding to the category of the most frequently used content as the first type of advertisement. The user's disposition, interest, life pattern, or lifetype is determined through the content that is most frequently used by the user. Therefore, the first type of advertisement is selected as a type of advertisement corresponding to the category of the most frequently used content in order to thereby provide the advertisement that is more customized for the user.

The communication module 510 may further receive the first user information that is identified based on the first voice input from the electronic device 101. The first user information includes at least one of the age and the gender information.

If there are a plurality of types of advertisements that correspond to the category of the content that is most frequently used, the processing module 520 selects the first type of advertisement based on at least one piece of the age information and the gender information, which are contained in the first user information. If there are a plurality of types of advertisements corresponding to the category of the most frequently used content, an additional reference to select the first type of advertisement may be required. At least one piece of the age information or the gender information may be used as the reference for selecting the first type of advertisement.

If the first usage history information is not received, the communication module 510 receives at least one of the age and the gender information, which are extracted from the first voice input. If the first voice input is received from the user who has never used the electronic device 101 before, the user information on the user may not be stored in the electronic device 101. In this case, since the first user information corresponding to the first voice input may not be identified, at least one of the age and the gender information, which are extracted from the first voice input, may be received.

If the first user information is not received, the processing module 520 selects the first type of advertisement based on at least one of the age and the gender information, which are extracted from the received first voice input.

The processing module 520 selects one or more second advertisements that are related to the first advertisement based on the first usage history information. The second advertisement may be for the second advertisement target that is not the same as, but is similar to the first advertisement target. The communication module 510 transmits the one or more selected second advertisements to the electronic device 101. Accordingly, the server 500 may additionally provide the advertisements for various advertisement targets related to the user's disposition, interest, lifetype, or life pattern.

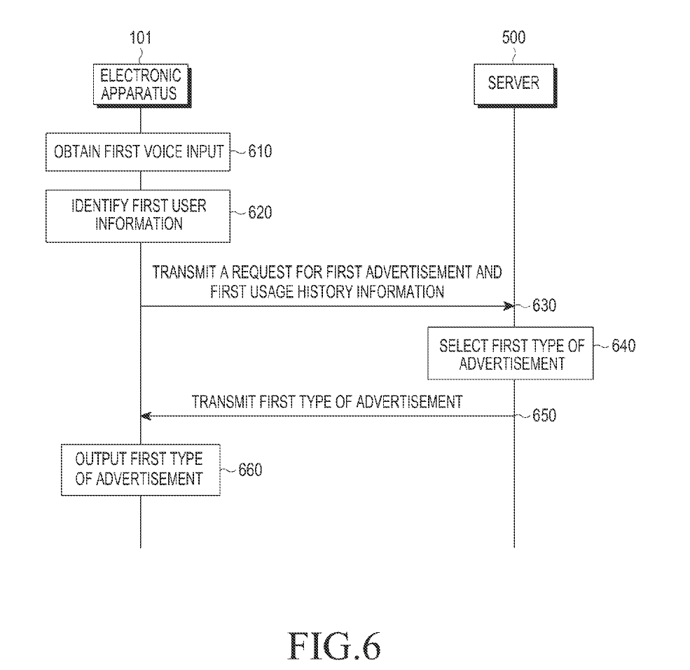

FIG. 6 illustrates an advertisement providing method by the electronic apparatus and the server, according to an embodiment of the present disclosure.

In step 610, the electronic device 101 receives the first voice input, which requests the first advertisement, from the user. The electronic device 101 outputs a banner for the first advertisement. The first advertisement may or may not be a banner advertisement.

In step 620, the electronic device 101 identifies the first user information corresponding to the first voice input, among the user information of a plurality of users. The user information includes at least one piece of unique voice information of each user, such as a frequency, a waveform, or an amplitude of the user's voice, or the age or gender information, which are extracted from the user's voice.

The age and gender information may be extracted from the user's voice through a database that records voices according to age or gender. The unique voice information of each user may be compared with the voices that are recorded in the database according to age or gender, and at least one of the age and gender information corresponding to the user's voice may be extracted. For example, voice ranges, depth, or tones of the voices, which are registered in the database according to age or gender, may be compared with a voice range, depth, or a tone of the user's voice in order to thereby extract at least one of the age and gender information from the user's voice.

In step 630, the electronic device 101 transmits, to the server 500, the request for the first advertisement and the first usage history information corresponding to the first user information. The first usage history information may be used to select a type of advertisement that is customized for the user who has provided the first voice input, from among a plurality of types of advertisements corresponding to the first advertisement.

In step 640, the server 500 selects the first type of advertisement from among a plurality of types of advertisements corresponding to the first advertisement, based on the request for the first advertisement and the first usage history information received in step 630.

In step 650, the server 500 transmits the first type of advertisement that is selected in step 640 to the electronic device 101.

In step 660, the electronic device 101 outputs, on the display, the first type of advertisement that is received in step 650, through either part of or the entire area of the display.

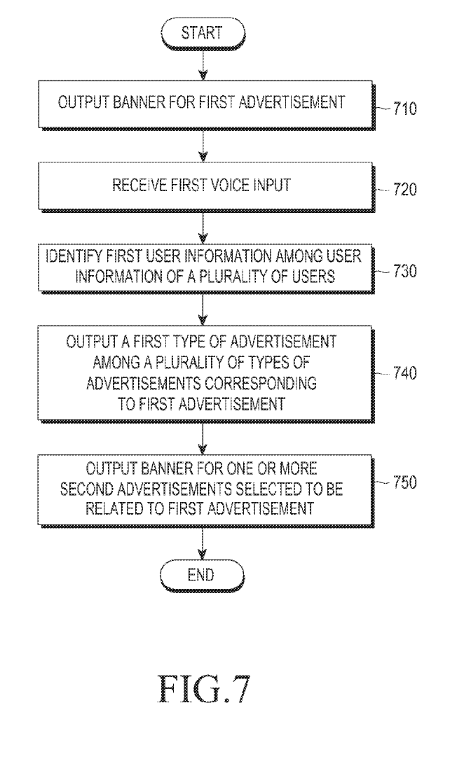

FIG. 7 illustrates an advertisement providing method by the electronic apparatus, according to an embodiment of the present disclosure.

In step 710, the electronic device 101 outputs a banner for the first advertisement. The electronic device 101 outputs, on the display, various types of advertisements, such as banner, video, audio, and image advertisements. The electronic device 101 outputs the first advertisement to be displayed on the display through a predetermined banner.

In step 720, the electronic device 101 receives the first voice input that requests the first advertisement. The electronic device 101 transmits a request for the first advertisement to the server 500 according to the first voice input.

In step 730, the electronic device 101 identifies the first user information corresponding to the first voice input, from among the user information of a plurality of users. The electronic device 101 compares the voice information of the first voice input with the voice information of each user contained in the user information in order to thereby identify the first user information.

For example, the electronic device 101 compares the first voice input with the user's voice characteristics, such as at least one of a frequency, a waveform, or an amplitude thereof, which correspond to each piece of user information of a plurality of users, in order to thereby recognize the first user information. All or at least one of the frequency, the waveform, and the amplitude may be used to identify the first user information. In addition, a selective combination of the frequency, the waveform, and the amplitude may be used to identify the first user information.

In step 740, the electronic device 101 outputs the first type of advertisement that is selected based on the first usage history information corresponding to the first user information, among a plurality of types of advertisements corresponding to the first advertisement. Accordingly, the electronic device 101 provides the first type of advertisement that is customized to the user who has provided the first voice input.

In step 750, the electronic device 101 outputs a banner for one or more second advertisements that are selected to be related to the first advertisement. The second advertisement may be for the second advertisement target that is not the same as, but is similar or related to the first advertisement target. For example, if the first advertisement target is a vehicle, the second advertisement target may be a vehicle-related product or a vehicle that is manufactured by another manufacturer different from the manufacturer of the vehicle.

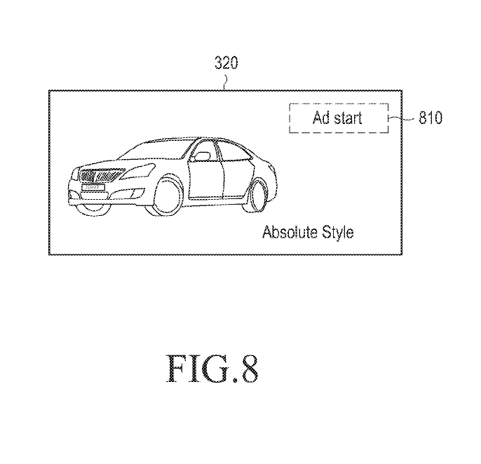

FIG. 8 illustrates a banner for the advertisement, according to an embodiment of the present disclosure.

The electronic device 101 outputs a banner 320 for the advertisement through the display. The advertisement may relate to a vehicle, and may be output on a predetermined banner 320. Advertisement request text 810 is displayed on the banner 320. The user makes a voice input corresponding to the advertisement request text 810 into the electronic device 101. For example, the user views the advertisement request text 810 of “AD Start,” and makes a first voice input by speaking “AD Start” into the electronic device 101. Thus, the electronic device 101 recognizes that the first voice input requests an advertisement for the vehicle displayed on the banner, and transmits a request for the advertisement of the vehicle to the server 500 according to the first voice input.

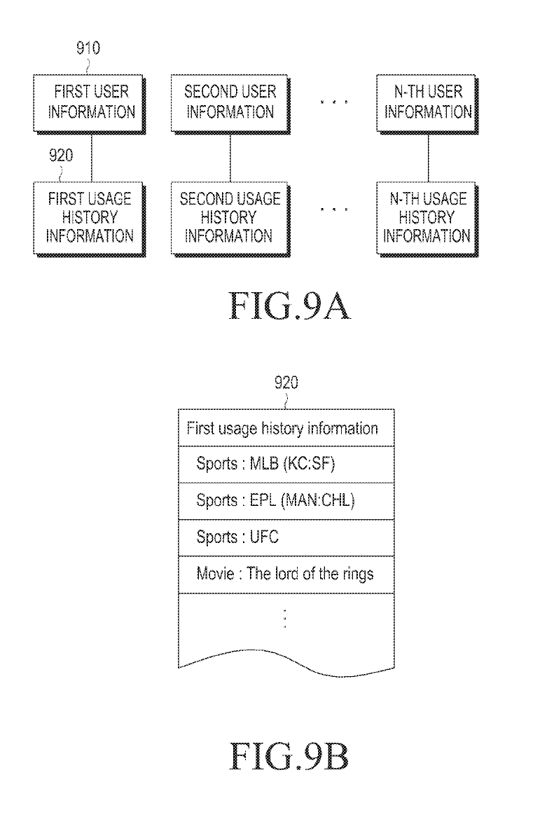

FIG. 9A is a conceptual diagram showing the relationship between the user information and the usage history information for a plurality of users, according to an embodiment of the present disclosure.

The electronic device 101 includes the user information for each of a plurality of users who have used the electronic device 101. When the plurality of users have used the electronic device 101 through voice inputs, the electronic device 101 identifies the users according to the voice of each of the plurality of users. For example, the electronic device 101 identifies each of the plurality of users based on at least one of a frequency, a waveform, and an amplitude of the voice input. The electronic device 101 creates the user information about each user who is separated. In addition, the electronic device 101 includes one or more pieces of voice information among the frequency, the waveform, or the amplitude of the voice input of each user, which are used to distinguish between the users. Accordingly, it is possible to identify the first user information corresponding to the first voice input received.

In addition, the user information may be created by the user through input means other than the voice input, such as through a remote controller. In this case, the user selects the user information through the remote controller, and inputs his/her voice so that one or more pieces of voice information among the frequency, the waveform, or the amplitude may be included.

The electronic device 101 stores the user information and the usage history information for each of the plurality of users such that the user information is paired with the usage history information. In addition, the user information includes the usage history information. For example, when the first user uses the first content through the voice input, the information about the first content that the first user has used is stored in the first usage history information corresponding to the first user information. In addition, when the first user selects his/her own first user information through other input means and uses the second content, the information about the second content that the first user has used is stored in the first usage history information as well. The information about the content includes a content name, a content usage time, a content category, and the frequency of content usage, for example.

As described above, the electronic device 101 stores the information about the content that each user has used in the usage history information corresponding to the user information of each user. The information about the content that the user has used, which is stored in the usage history information, may be used to provide a type of advertisement that is customized for the user. In addition, the user's disposition, interest, or lifetype may be determined based on the information about the content that the user has used. Accordingly, a type of advertisement corresponding to the user's disposition, interest, or life type may be provided.

FIG. 9B is a conceptual diagram of the usage history information, according to an embodiment of the present disclosure.

FIG. 9B illustrates an example of the first usage history information corresponding to the first user information. The first usage history information includes the information showing that the first user has used the sports content, such as major league baseball (MLB) (Kansas City: San Francisco (KC: SF)), european premier league (EPL) (Manchester (MAN): Chelsea (CHL)), or ultimate fighting championship (UFC), and movie content, such as The Lord of the Rings. In addition, the content category that the first user has used may be additionally included. Accordingly, it may be determined that the first user frequently uses the content of the sports category, and thus a type of advertisement corresponding to the sports category may be determined to be the first type of advertisement to be provided to the first user.

In addition, if the first user frequently uses the first content, a type of advertisement corresponding to the category of the first content may be determined to be the first type of advertisement.

In an embodiment, the first usage history information includes the information corresponding to a reference by which a plurality of types of advertisements are produced in consideration of lifetypes of typical users. The advertiser configures various lifetypes of the users who are provided with the advertisements according to a predetermined reference, and produces the plurality of types of advertisements to be different from each other to correspond to each of the configured lifetypes. In addition, the category of the content may be configured to also correspond to each of the configured lifetypes. For example, the category of the content corresponding to the first lifetype may be configured as the first category and the second category, and the category of the content corresponding to the second lifetype may be configured as the third category.

Accordingly, if the first user frequently uses the content corresponding to the first category and the second category, the lifetype of the first user may be determined to be the first lifetype, and a type of advertisement corresponding to the first lifetype is selected as the first type of advertisement.

In addition to the information included in the first usage history information set forth above, the first usage history information includes various pieces of information that can be used for providing customized advertisements to the user.

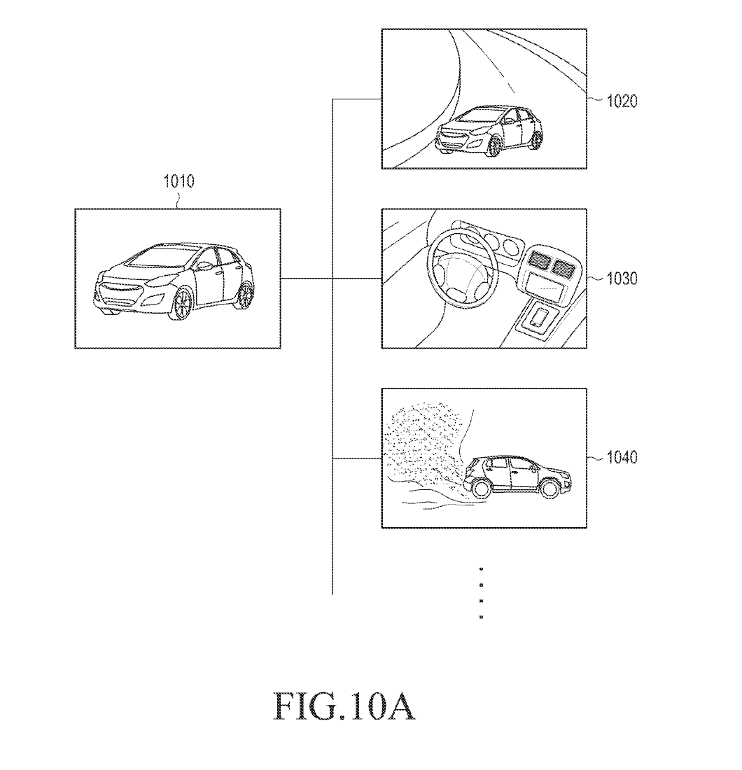

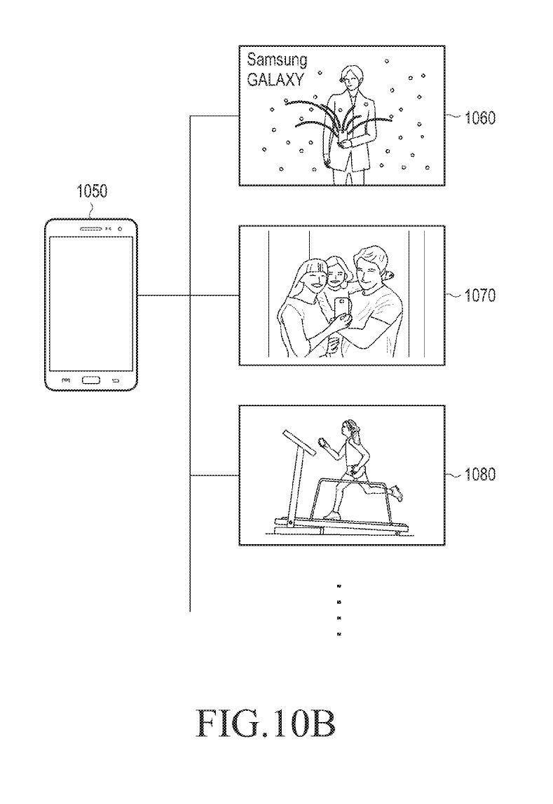

FIG. 10A illustrates a plurality of types of advertisements corresponding to the first advertisement, according to an embodiment of the present disclosure.

FIG. 10A illustrates a plurality of types of advertisements 1020, 1030, and 1040 corresponding to the first advertisement 1010 for a vehicle. The server 330 includes the plurality of types of advertisements corresponding to the first advertisement 1010 for a vehicle. For example, it is possible to produce various advertisements for a vehicle, such as the first type of advertisement 1020 that is produced to focus on the outer design of the vehicle, the second type of advertisement 1030 that is produced to focus on the internal design of the vehicle, and the third type of advertisement 1040 that is produced to focus on the off-road driving performance of the vehicle. Considering dispositions, interests, or lifetypes of various viewers who are provided with the advertisement, various types of advertisements may be produced to highlight various features of the product of the advertisement target. As described above, the advertiser produces a plurality of types of advertisements for the product of a single advertisement target, and provides the advertisements customized for the targeted viewers to maximize the effect of the advertisement.

The advertisement, which is output through the electronic device 101 among a plurality of types of advertisements corresponding to the first advertisement 1010, is selected based on the first usage history information for the first user. In an embodiment, the advertisement that is output through the electronic device 101 is selected according to the category of the used content that is determined based on the first usage history information.

For example, if the category of the content that the first user has used is a fashion-related category, the first type of advertisement 1020, which is produced to focus on the outer design of the vehicle, is selected as the advertisement that is to be output through the electronic device 101. If the category of the content that the first user has used is a home drama category, the second type of advertisement 1030, which is produced to focus on the internal design of the vehicle, is selected as the advertisement that is to be output through the electronic device 101. If the category of the content that the first user has used is a sports category, the third type of advertisement 1040, which is produced to focus on the off-road driving of the vehicle, is selected as the advertisement that is to be output through the electronic device 101.

FIG. 10B illustrates a plurality of types of advertisements corresponding to the first advertisement, according to an embodiment of the present disclosure.

FIG. 10B illustrates a plurality of types of advertisements 1060, 1070, and 1080 corresponding to the first advertisement 1050 for a smart phone. The server 330 includes the plurality of types of advertisements corresponding to the first advertisement 101 for a mobile phone. For example, it is possible to produce various advertisements for a smart phone, such as the first type of advertisement 1060 that is produced to have a concept of introducing functions of the smart phone, the second type of advertisement 1070 that is produced to have a concept in which family members share the smart phone with each other, and the third type of advertisement 1080 that is produced to have a concept in which the user uses the smart phone during the exercise. Considering dispositions, interests, or lifetypes of various viewers who are provided with the advertisements, various types of advertisements may be produced to have various concepts for the product of the advertisement target.

The advertisement, which is output through the electronic device 101 among a plurality of types of advertisements corresponding to the first advertisement 1050, is selected based on the first usage history information of the first user. In an embodiment, the advertisement is selected according to the category of the used content that is determined based on the first usage history information.

For example, if the category of the content that the first user has used is an entertainment-related category, the first type of advertisement 1060, which is produced to have a concept of introducing functions of the smart phone, is selected as the advertisement that is to be output through the electronic device 101. If the category of the content that the first user has used is a home drama category, the second type of advertisement 1070, which is produced to have a concept in which family members share the smart phone, is selected as the advertisement that is to be output through the electronic device 101. If the category of the content that the first user has used is a sports category, the third type of advertisement, which is produced to have a concept in which the user uses the smart phone during the exercise, is selected as the advertisement that is to be output through the electronic device 101.

As described in FIG. 10A and FIG. 10B, the advertisement is selected based on the category of the content that the user has used. The category of the content corresponding to each of the plurality of types of advertisements may be configured in consideration of dispositions, interests, or lifetypes of the viewers who are targeted with each type of advertisement. Accordingly, it is possible to maximize the effect of the advertisement by providing the advertisements customized for the targeted viewers.

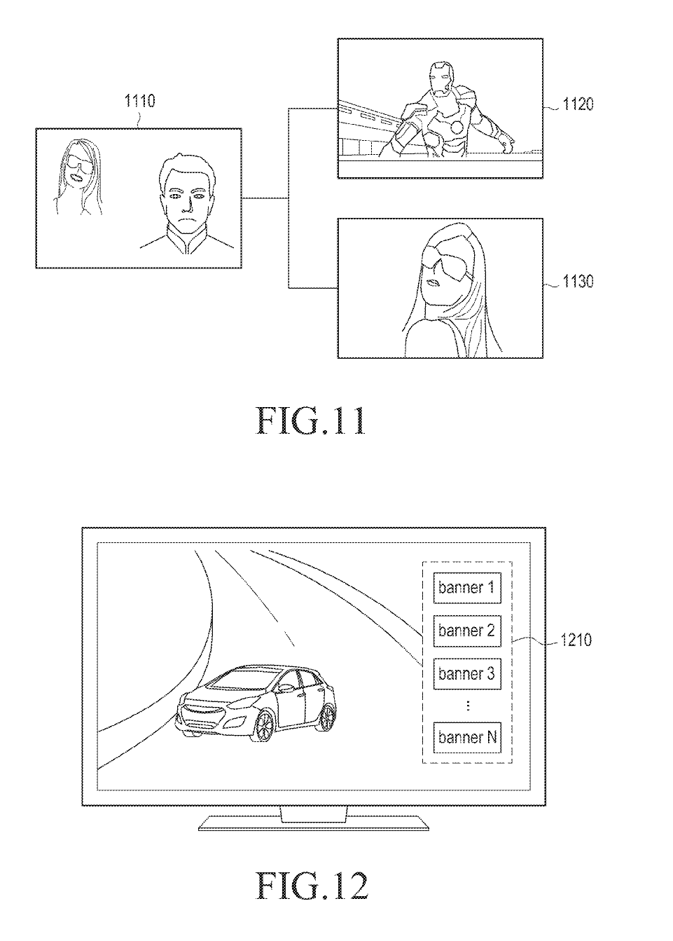

FIG. 11 illustrates a plurality of types of advertisements corresponding to the first advertisement, according to an embodiment of the present disclosure.

Specifically, FIG. 11 illustrates a plurality of types of advertisements 1120 and 1130 included in the server 330 and corresponding to the first advertisement 1110 for a movie. For example, it is possible to produce various advertisements for a movie, such as the first type of advertisement 1120 that is produced based on action scenes of the movie, and the second type of advertisement 1130 that is produced based on melodramatic scenes. Various types of advertisements may be produced in consideration of interests of the viewers who are provided with the advertisement, depending on the viewer's gender.

The advertisement, therefore, is selected based on the gender information of the first user.

For example, if the gender of the first user is male, the first type of advertisement 1120, which is produced based on action scenes of the movie, is selected as the advertisement that is to be output through the electronic device 101. If the gender of the first user is female, the second type of advertisement 1130, which is produced based on melodramatic scenes, is selected as the advertisement that is to be output through the electronic device 101.

As described above, the advertisement, which is output through the electronic device 101 among a plurality of types of advertisements, is selected based on the gender information of the user. In addition, various types of advertisements may be produced in consideration of interests of the viewers according to age. For example, more colorful conceptual advertisements may be produced for teenagers, and family-conceptual advertisements may be produced for the viewers in their forties. Accordingly, the advertisement is selected based on the age information of the user.

FIG. 12 illustrates an electronic apparatus that outputs banners for the second advertisement that is selected to be related to the first advertisement, according to an embodiment of the present disclosure.

As shown in FIG. 12, the electronic device 101 outputs banners 1210 for one or more second advertisements that are selected to be related to the first advertisement, based on the first usage history information. The electronic device 101 outputs the first type of advertisement that is selected based on the first usage history information, from among a plurality of types of advertisements. In addition, the electronic device 101 outputs the banners 1210 for the second advertisement in some area of the display while simultaneously outputting the first type of advertisement on another area of the display.

The second advertisement may be for the second advertisement target that is not the same as, but is similar or related to the first advertisement target. For example, when the first advertisement target is a vehicle, the advertisement for a vehicle-related product may be output in the first banner, and a vehicle that is manufactured by another manufacturer may be output in the second banner.

As described above, the electronic device 101 outputs the second advertisement for the second advertisement target that is similar or related to the first advertisement target in order to thereby additionally provide the advertisements for various advertisement targets related to, for example, the user's disposition, interest, or lifetype.

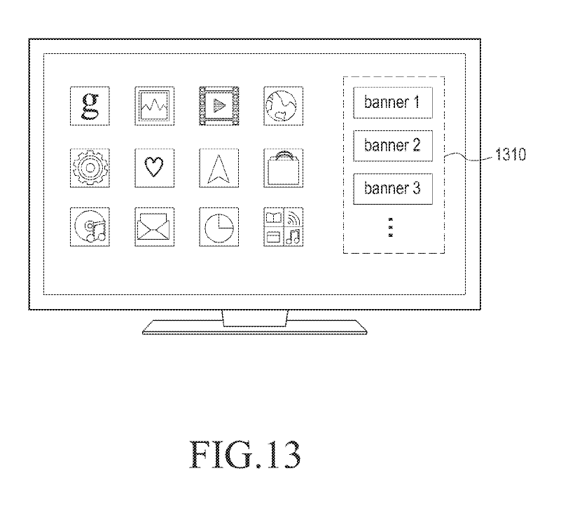

FIG. 13 illustrates an electronic apparatus that outputs a plurality of banner advertisements that are selected based on the usage history information, according to an embodiment of the present disclosure.

As shown in FIG. 13, the electronic device 101 outputs a plurality of banner advertisements that are selected based on the usage history information. The electronic device 101 outputs banner advertisements that correspond to the user's disposition, interest, or lifetype, which are determined based on the usage history information, and have characteristics of type of content and proper corresponding advertisements that are pre-configured as shown in Table 1 below.

TABLE 1

| Lifetype | Type of Content | Selected Type of Advertisement |
|---|---|---|
| Social Butterflies | SNS | Advertisement for SNS sharing, |
| | | Event participation providing |
| | | advertisement through SNS |
| Fact Finders | Youtube, Search | Advertisement for providing |
| | Engine (Google) | information and specification of |
| | | Product |
| Deal Hunters | Shopping, | Advertisement for providing |
| | Commercial site | vouchers |
| Social Gamers | Game | Advertisement related to event |
| | | participation and games |

As shown in Table 1, the lifetypes, such as Social Butterflies, Fact Finders, Deal Hunters, and Social Garners, are pre-configured in order to provide a proper advertisement according to the user's lifetype, among a plurality of types of advertisements.

For example, the lifetype of “Social Butterflies” is configured as a characteristic to enjoy social activities. In this case, the SNS content is configured to correspond to the lifetype of “Social Butterflies” from among the available content in the electronic device 101. If the frequency of using the SNS content is determined to be high from the usage history information of the user, the user's lifetype is determined to be “Social Butterflies,” and the electronic device 101 outputs banner advertisements for SNS-shareable advertisements, or event-participation advertisements through the SNS.

Likewise, the content among the available content in the electronic device 101 may be configured to correspond to each of the lifetypes, such as the lifetype of “Fact Finders” that has a characteristic of sharing and evaluating accurate information about products, the lifetype of “Deal Hunters” that has a characteristic of enjoying purchasing products through shopping sites, or the lifetype of “Social Garners” that has a characteristic of enjoying playing games. Although the electronic apparatus that outputs the banner advertisements is shown in FIG. 13, the electronic apparatus is not limited thereto, and may output various types of advertisements.

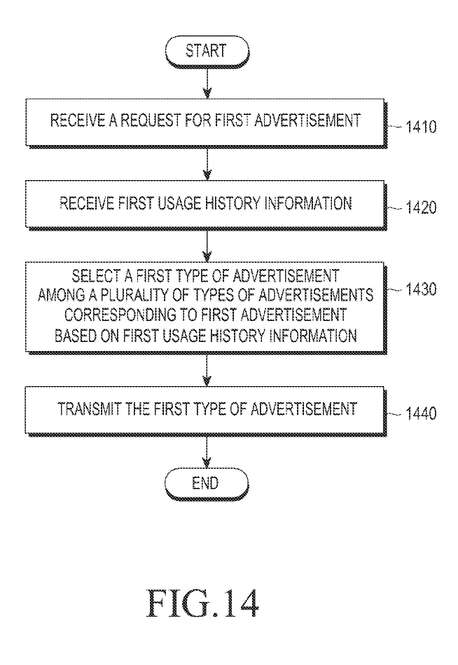

FIG. 14 illustrates an operating method of a server, according to an embodiment of the present disclosure.

In step 1410, the server 500 receives a request for the first advertisement from the electronic apparatus 100, such as by the first voice input received in the electronic device 101.

In step 1420, the server 500 receives the first usage history information corresponding to the first user information that is identified through the first voice input. The first usage history information may be used to select an advertisement suitable for the user who has provided the first voice input from among a plurality of types of advertisements corresponding to the first advertisement.

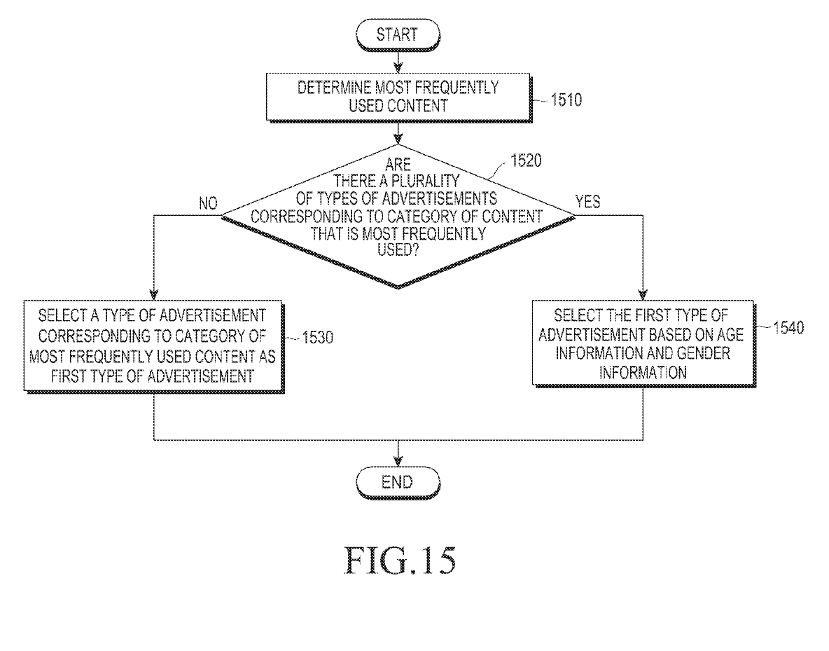

In step 1430, the server 500 selects the first type of advertisement from among a plurality of types of advertisements corresponding to the first advertisement, based on the first usage history information. Selecting the first type of advertisement will be described in detail with reference to FIG. 15 later herein.

In step 1440, the server 500 transmits the selected first type of advertisement to the electronic device 101. Accordingly, the electronic device 101 outputs the first type of advertisement that is customized for the user who has provided the first voice input.

FIG. 15 illustrates a method for selecting the first type of advertisement, according to an embodiment of the present disclosure.

In step 1510, the server 500 determines the content that is most frequently used based on the first usage history information. The user's disposition, interest, lifetype, or life pattern is determined through the content that is most frequently used.

In step 1520, the server 500 determines whether there are a plurality of types of advertisements that correspond to the category of the most frequently used content. If there are, an additional reference for selecting the first type of advertisement is required.

In step 1530, if there is no plurality of types of advertisements that correspond to the category of the most frequently used content, the server 500 determines a type of advertisement that corresponds to the category of the most frequently used content to be the first type of advertisement.

In step 1540, if there are a plurality of types of advertisements that correspond to the category of the most frequently used content, the server 500 selects the first type of advertisement based on the age or gender information contained in the first user information that is identified through the first voice input. The server 500 uses this information as an additional reference for determining the first type of advertisement. If there are a plurality of types of advertisements that correspond to the user's disposition, interest, or lifetype, such as the usage history information, the server determines the first type of advertisement by further considering general dispositions, interests, or lifetypes according to age or gender.

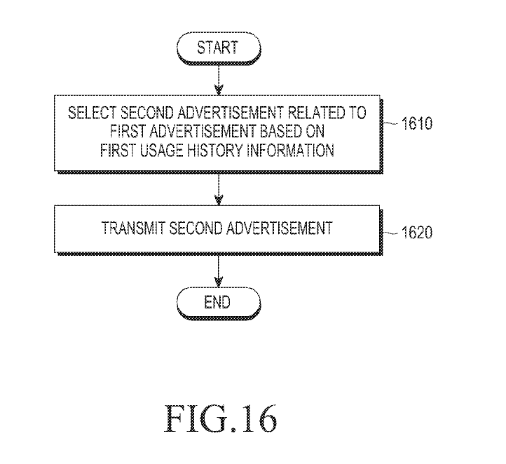

FIG. 16 illustrates a method for providing the second advertisement that is related to the first advertisement, according to an embodiment of the present disclosure.

In step 1610, the server 500 selects the second advertisement that is related to the first advertisement based on the first usage history information. The second advertisement is for the second advertisement target that is not the same as the first advertisement target, but is similar or related to the first advertisement target.

In step 1620, the server 500 transmits the second advertisement to the electronic device 101. Accordingly, the server 500 may additionally provide the user with the advertisements for various advertisement targets related to the user's disposition, interest, or lifetype, for example.

The following aspects are according to embodiments of the present disclosure:

A method for providing advertisements includes outputting a banner for the first advertisement; receiving the first voice input that requests the first advertisement, identifying the first user information that corresponds to the first voice input, from among the user information of a plurality of users, and outputting the first type of advertisement that is selected based on the first usage history information that corresponds to the first user information, from among a plurality of types of advertisements that correspond to the first advertisement.

The plurality of types of advertisements are produced to be different from each other, based on at least one of a category to which the content belongs, age information, or gender information.

The first type of advertisement is selected as a type of advertisement that corresponds to the category of the content that is most frequently used, which is determined based on the first usage history information.

If there are a plurality of types of advertisements that correspond to the category of the most frequently used content, the first type of advertisement is selected based on at least one piece of age information or gender information, which are contained in the first user information.

The first voice input corresponds to advertisement request text for the first advertisement, which is displayed on the banner.

Identifying the first user information includes comparing the first voice input with at least one of a frequency, a waveform, or an amplitude of the user's voice that corresponds to each piece of user information of the plurality of users, and identifying the first user information.

If the first user information corresponding to the first voice input is not identified, the first type of advertisement is selected based on at least one of age and gender information, which are extracted from the first voice input.

The method further includes outputting banners for one or more second advertisements that are selected to be related to the first advertisement based on the first usage history information.

An electronic apparatus includes a display that outputs a banner for the first advertisement; a controller that controls to receive the first voice input that requests the first advertisement, to identify the first user information that corresponds to the first voice input, from among the user information for a plurality of users, and to output the first type of advertisement that is selected based on the first usage history information that corresponds to the first user information, from among a plurality of types of advertisements that correspond to the first advertisement.

The plurality of types of advertisements are produced to be different from each other, based on at least one of a category to which the content belongs, age information, and gender information.

The first type of advertisement is selected as a type of advertisement that corresponds to the category of the content that is most frequently used, which is determined based on the first usage history information.

If there are a plurality of types of advertisements that correspond to the category of the most frequently used content, the first type of advertisement is selected based on at least one of age and gender information, which are included in the first user information.

The first voice input corresponds to advertisement request text for the first advertisement, which is displayed on the banner.

The processor compares the first voice input with at least one of a frequency, a waveform, or an amplitude of the user's voice that corresponds to each piece of user information of the plurality of users, and identifies the first user information.

If the first user information corresponding to the first voice input is not identified, the first type of advertisement is selected based on at least one of age and gender information, which are extracted from the first voice input.

The processor controls to output banners for one or more second advertisements that are selected to be related to the first advertisement based on the first usage history information.

An operating method of a server that provides advertisements to an electronic apparatus includes receiving a request for the first advertisement from the electronic apparatus, the first advertisement requested by the first voice input received in the electronic apparatus, receiving the first usage history information that corresponds to the first user information that is identified through the first voice input, selecting the first type of advertisement from among a plurality of types of advertisements that correspond to the first advertisement, based on the first usage history information, and transmitting the first type of advertisement.

The plurality of types of advertisements is produced to be different from each other, based on at least one of a category to which the content belongs, age information, and gender information.

Selecting the first type of advertisement includes determining the content that is most frequently used based on the first usage history information, and selecting, as the first type of advertisement, a type of advertisement that corresponds to the category of the most frequently used content.

Receiving the first usage history information further comprises receiving the first user information.

When selecting the first type of advertisement, if there are a plurality of types of advertisements that correspond to the category of the most frequently used content, the first type of advertisement is selected based on at least one of age and gender information, which are contained in the first user information.

The method further includes, if the first usage history information is not received, receiving at least one of age and gender information, which are extracted from the first voice input.

Selecting the first type of advertisement includes selecting the first type of advertisement based on at least one piece of the age information or the gender information.

The method further includes selecting one or more second advertisements that are related to the first advertisement based on the first usage history information, and transmitting the second advertisement.

A server for providing advertisements to an electronic apparatus includes a communication module that receives a request for the first advertisement from the electronic apparatus, the first advertisement requested by the first voice input being received from the electronic apparatus, and receives the first usage history information that corresponds to the first user information that is identified through the first voice input, and a controller that selects the first type of advertisement from among a plurality of types of advertisements that correspond to the first advertisement, based on the first usage history information, and transmits the first type of advertisement through the communication module.

The plurality of types of advertisements is produced to be different from each other, based on at least one of a category to which the content belongs, age information, and gender information.

The controller determines the content that is most frequently used based on the first usage history information, and selects, as the first type of advertisement, a type of advertisement that corresponds to the category of the most frequently used content.

The communication module further receives the first user information.

If there are a plurality of types of advertisements that correspond to the category of the most frequently used content, the controller selects the first type of advertisement based on at least one of age and gender information, which are included in the first user information.

If the first usage history information is not received, the communication module receives at least one of age and gender information, which are extracted from the first voice input.

The controller selects the first type of advertisement based on at least one of age and gender information.

The controller selects one or more second advertisements that are related to the first advertisement based on the first usage history information, and controls the communication module to transmit the second advertisement.

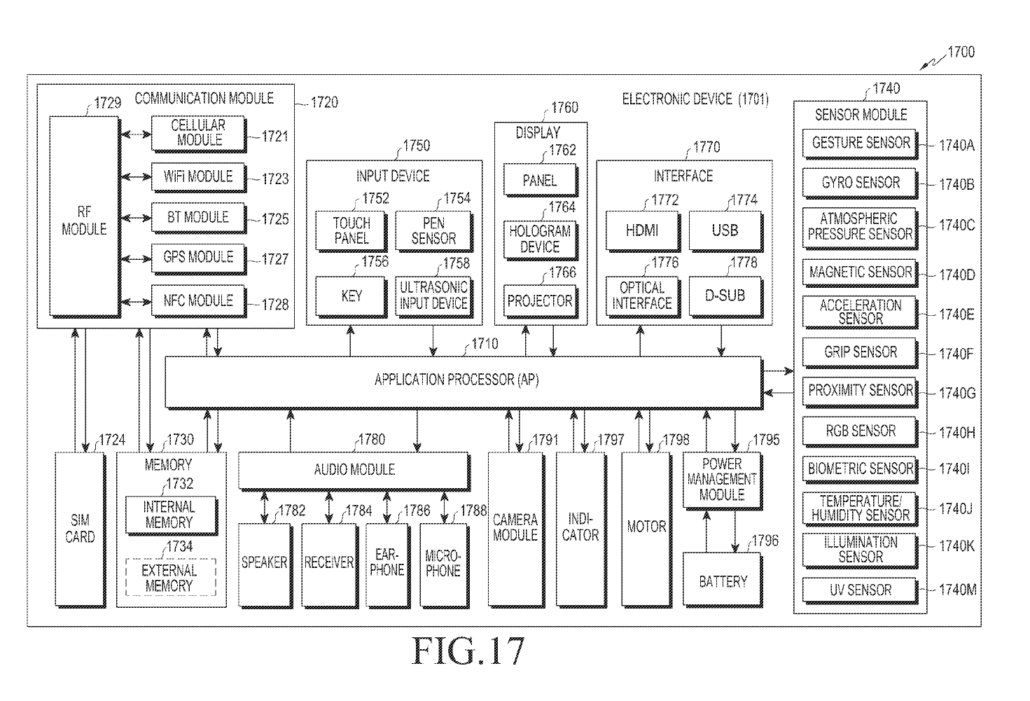

FIG. 17 is a block diagram 1700 of an electronic device 1701 according to an embodiment of the present disclosure. The electronic device 1701 includes some or all of the components of electronic device 101 illustrated in FIG. 1. The electronic device 1701 includes at least one AP 1710, a communication module 1720, a subscriber identification module (SIM) card 1724, a memory 1730, a sensor module 1740, an input device 1750, a display 1760, an interface 1770, an audio module 1780, a camera module 1791, a power management module 1795, a battery 1796, an indicator 1797, and a motor 1798.

The AP 1710 controls a plurality of hardware or software components connected thereto by driving an operating system or an application program and performs a variety of data processing and calculations. The AP 1710 may be embodied as, for example, a system on chip (SoC) and may further include a graphical processing unit (GPU) and/or an image signal processor. The AP 1710 may also include at least some of the components illustrated in FIG. 17, may load instructions or data, received from at least one other component, in a volatile memory to process the loaded instructions or data, and may store various types of data in a non-volatile memory.

The communication module 1720 is configured identically or similarly to the communication interface 170 of FIG. 1 and includes a cellular module 1721, a WiFi module 1723, a Bluetooth® (BT) module 1725, a GPS module 1727, an NFC module 1728, and a radio frequency (RF) module 1729.

The cellular module 1721 provides a voice call, video call, text message services, or Internet services through, for example, a communication network. According to an embodiment, the cellular module 1721 distinguishes between and authenticates electronic devices 1701 within a communication network using a SIM card 1724. According to an embodiment of the present disclosure, the cellular module 1721 performs at least some of the functions which may be provided by the AP 1710, and includes a communication processor (CP).

The Wi-Fi module 1723, the BT module 1725, the GPS module 1727, and the NFC module 1728 include, for example, a processor for processing data transmitted/received through the corresponding module. Two or more of the cellular module 1721, the WiFi module 1723, the BT module 1725, the GPS module 1727, and the NFC module 1728 may be included in one integrated chip (IC) or IC package.

The RF module 1729 transmits/receives a communication signal such as an RF signal. The RF module 1729 includes, for example, a transceiver, a power amp module (PAM), a frequency filter, a low noise amplifier (LNA) or an antenna. According to another embodiment, at least one of the cellular module 1721, the WiFi module 1723, the BT module 1725, the GPS module 1727, and the NFC module 1728 transmits/receives an RF signal through a separate RF module.

The SIM card 1724 includes a subscriber identification module and/or an embedded SIM, and includes unique identification information such as an integrated circuit card identifier (ICCID)) or subscriber information such as an international mobile subscriber identity (IMSI)).

The memory 1730 includes an internal memory 1732 and may include an external memory 1734. The internal memory 1732 includes at least one of a volatile memory such as a dynamic random access memory (DRAM), a static RAM (SRAM), a synchronous dynamic RAM (SDRAM), and a non-volatile memory such as a one time programmable read only memory (OTPROM), a programmable ROM (PROM), an erasable and programmable ROM (EPROM), an electrically erasable and programmable ROM (EEPROM), a flash memory such as a NAND flash memory or a NOR flash memory, a hard driver, or a solid state drive (SSD).

The external memory 1734 may further include a flash drive, for example, a compact flash (CF), a secure digital (SD), a micro secure digital (Micro-SD), a mini secure digital (Mini-SD), an extreme digital (xD), or a memory stick. The external memory 1734 may be functionally and/or physically connected to the electronic device 1701 through various interfaces.

The sensor module 1740 measures, for example, a physical quantity or detects an operation state of the electronic device 1701, and converts the measured or detected information to an electrical signal. The sensor module 1740 includes, for example, at least one of a gesture sensor 1740A, a gyro sensor 1740B, an atmospheric pressure sensor 1740C, a magnetic sensor 1740D, an acceleration sensor 1740E, a grip sensor 1740F, a proximity sensor 1740G, a color sensor 1740H such as a red, green, and blue (RGB) sensor, a biometric sensor 8401, a temperature/humidity sensor 1740J, an illumination sensor 1740K, and an Ultra Violet (UV) sensor 1740M.

Additionally or alternatively, the sensor module 1740 may include an E-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 1740 may further include a control circuit for controlling at least one sensor included therein. In any embodiment, the electronic device 1701 further includes a processor configured to control the sensor module 1740 as a part of or separately from the AP 1710, and controls the sensor module 1740 while the AP 1710 is in a sleep state.

The input device 1750 includes a touch panel 1752, a (digital) pen sensor 1754, a key 1756, and an ultrasonic input device 1758, and uses at least one of a capacitive type, a resistive type, an infrared type, and an ultrasonic type. The touch panel 1752 may further include a control circuit, as well as a tactile layer that provides a tactile reaction to a user.

The (digital) pen sensor 1754 includes, for example, a recognition sheet which is a part of the touch panel or a separate recognition sheet. The key 1756 includes, for example, a physical button, an optical key or a keypad. The ultrasonic input unit 1758 inputs data through an input means that generates an ultrasonic signal, and the electronic device 1701 identifies data by detecting a sound wave with a microphone 1788.

The display 1760 includes a panel 1762, a hologram device 1764 and a projector 1766. The panel 1762 includes the same or similar components to those of the display 160 of FIG. 1, is flexible, transparent, or wearable, and may be integrated with the touch panel 1752 as a single module. The hologram device 1764 displays a stereoscopic image in the air by using interference of light. The projector 1766 projects light onto a screen to display an image. For example, the screen may be located inside or outside the electronic device 1701. According to an embodiment of the present disclosure, the display 1760 further includes a control circuit for controlling the panel 1762, the hologram device 1764, or the projector 1766.

The interface 1770 includes, for example, a high-definition multimedia interface (HDMI) 1772, a universal serial bus (USB) 1774, an optical interface 1776, or a D-subminiature (D-sub) 1778. The interface 1770 may be included in, for example, the communication interface 170 illustrated in FIG. 1. Additionally or alternatively, the interface 1770 includes a mobile high-definition link (MHL) interface, a secure digital (SD) card/multi-media card (MMC) interface, or an infrared data association (IrDA) standard interface.

The audio module 1780 bilaterally converts, for example, a sound and an electrical signal. At least some components of the audio module 1780 may be included in, for example, the input/output interface 140 illustrated in FIG. 1. The audio module 1780 processes sound information input or output through a speaker 1782, a receiver 1784, earphones 1786, or the microphone 1788.

The camera module 1791 photographs a still image and a dynamic image. According to an embodiment, the camera module 291 includes one or more image sensors such as a front sensor or a back sensor, a lens, an image signal processor (ISP) or a flash such as a light-emitting diode (LED) or xenon lamp.

The power management module 1795 manages power of the electronic device 1701. According to an embodiment, the power management module 1795 includes a power management integrated circuit (PMIC), a charger IC, or a battery or fuel gauge. The PMIC may have a wired and/or wireless charging scheme. Examples of the wireless charging method include a magnetic resonance method, a magnetic induction method, and an electromagnetic method. Additional circuits such as a coil loop, a resonance circuit, and a rectifier for wireless charging may be further included. The battery gauge 1796 measures, for example, the remaining amount of battery, a charging voltage and current, or temperature. The battery 1796 may be a rechargeable battery and/or a solar battery.

The indicator 1797 indicates particular status of the electronic device 1701 or a part thereof, such as a booting, message, or charging status. The motor 1798 converts an electrical signal into mechanical vibrations, and generates a vibration or haptic effect. Although not illustrated, the electronic device 1701 may include a processing device such as a GPU for supporting mobile TV. The processing device for supporting mobile TV processes media data according to a standard of digital multimedia broadcasting (DMB), digital video broadcasting (DVB), or media flow for example.

Each of the components of the electronic device according to the present disclosure may be implemented by one or more components and the name of the corresponding component may vary depending on a type of the electronic device. In embodiments, the electronic device may include at least one of the above-described elements. Some of the above-described elements may be omitted from the electronic device, or the electronic device may further include additional elements. Some of the components of the electronic device according to the embodiments of the present disclosure may be combined to form a single entity, and thus, may equivalently execute functions of the corresponding elements prior to the combination.

The term “module” as used herein may indicates a unit including one of hardware, software, and firmware or a combination of two or more of them. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of an application-specific integrated circuit (ASIC) chip, a field-programmable gate array (FPGA), and a programmable-logic device for performing operations which has been known or are to be developed hereinafter.

According to embodiments, at least some of the devices or the method according to the present disclosure may be implemented by a command stored in a computer-readable storage medium in a programming module form. When the command is executed by one or more processors, the one or more processors executes a function corresponding to the command. The computer-readable storage medium may be, for example, the memory 130.

The computer readable recoding medium includes a hard disk, a floppy disk, magnetic media such as a magnetic tape, optical media such as a compact disc read only memory (CD-ROM) and a digital versatile disc (DVD), magneto-optical media such as a floptical disk, a hardware device such as a ROM, a random access memory (RAM), and a flash memory. In addition, the program instructions include high class language codes, which can be executed in a computer by using an interpreter, as well as machine codes made by a compiler. The aforementioned hardware device may be configured to operate as one or more software modules in order to perform the operation of the present disclosure, and vice versa.

The programming module according to the present disclosure includes one or more of the aforementioned components or may further include other additional components, or some of the aforementioned components may be omitted. Operations executed by a module, a programming module, or other component elements according to embodiments of the present disclosure may be executed sequentially, in parallel, repeatedly, or in a heuristic manner. Some operations may be executed according to another order or may be omitted, or other operations may be added.

According to embodiments of the present disclosure, a recording medium may store instructions that are executed by one or more processors to perform one or more operations that include outputting a banner for the first advertisement, receiving the first voice input that requests the first advertisement, identifying the first user information that corresponds to the first voice input, from among the user information of a plurality of users, and outputting the first type of advertisement that is selected based on the first usage history information that corresponds to the first user information, from among a plurality of types of advertisements that correspond to the first advertisement.

Embodiments disclosed herein are provided merely to easily describe technical details of the present disclosure and to help the understanding of the present disclosure, and are not intended to limit the scope of the present disclosure. Therefore, it should be construed that all modifications and changes or modified and changed forms based on the technical idea of the present disclosure fall within the scope of the present disclosure.

While embodiments of the present disclosure are shown and described above, the present invention is not limited thereto and various changes to the described embodiments could be made without departing from the spirit and scope of the disclosure as defined by the appended claims.

What is claimed is:

1. A method for providing advertisements in an electronic device, the method comprising:
outputting a banner for a first advertisement;
receiving a first voice input that requests the first advertisement;
identifying first user information that corresponds to the first voice input, from among user information of a plurality of users; and
outputting a first type of advertisement that is selected based on first usage history information that corresponds to the first user information, from among a plurality of types of advertisements that correspond to the first advertisement.

2. The method of claim 1, wherein the plurality of types of advertisements are produced to be different from each other, based on at least one of a category to which the content belongs, age information, and gender information.

3. The method of claim 1, wherein the first type of advertisement is selected as corresponding to a category of content that is most frequently used by a user of the electronic device, which is determined based on the first usage history information.

4. The method of claim 3, wherein if there are a plurality of types of advertisements that correspond to a category of most frequently used content, the first type of advertisement is selected based on at least one of age information and gender information, which are included in the first user information.

5. The method of claim 1, wherein the first voice input corresponds to advertisement request text for the first advertisement, which is displayed on the banner.

6. The method of claim 1, wherein identifying the first user information comprises comparing the first voice input with at least one of a frequency, a waveform, and an amplitude of the user's voice that corresponds to each piece of user information of the plurality of users, and identifying the first user information.

7. The method of claim 6, wherein if the first user information corresponding to the first voice input is not identified, the first type of advertisement is selected based on at least one of age information and gender information, which are extracted from the first voice input.

8. The method of claim 1, further comprising outputting banners for one or more second advertisements that are selected to be related to the first advertisement based on the first usage history information.

9. An electronic device comprising:
a display that outputs a banner for a first advertisement; and
a controller that controls to receive a first voice input that requests the first advertisement, to identify first user information that corresponds to the first voice input, from among user information for a plurality of users, and to output a first type of advertisement that is selected based on the first usage history information that corresponds to the first user information, from among a plurality of types of advertisements that correspond to the first advertisement.

10. The electronic device of claim 9, wherein the plurality of types of advertisements are produced to be different from each other, based on at least one of a category to which the content belongs, age information, and gender information.

11. The electronic device of claim 9, wherein the first type of advertisement is selected as corresponding to a category of content that is most frequently used by a user of the electronic device, which is determined based on the first usage history information.

12. The electronic device of claim 11, wherein if there are a plurality of types of advertisements that correspond to the category of the most frequently used content, the first type of advertisement is selected based on at least one of age information and gender information included in the first user information.

13. The electronic device of claim 9, wherein the first voice input corresponds to advertisement request text for the first advertisement, which is displayed on the banner.

14. The electronic device of claim 9, wherein the controller further controls to compare the first voice input with at least one of a frequency, a waveform, and an amplitude of a user's voice that corresponds to each piece of user information of a plurality of users, and to identify the first user information based on the comparison.

15. The electronic device of claim 14, wherein if the first user information corresponding to the first voice input is not identified, the first type of advertisement is selected based on at least one of age information and gender information, which are extracted from the first voice input.

16. The electronic device of claim 9, wherein the controller further controls to output banners for one or more second advertisements that are selected to be related to the first advertisement based on the first usage history information.

17. A method of a server that provides advertisements to an electronic device, the method comprising:
receiving a request for a first advertisement from a first voice input received in the electronic device;
receiving first usage history information that corresponds to first user information that is identified through the first voice input;
selecting a first type of advertisement from among a plurality of types of advertisements that correspond to the first advertisement, based on the first usage history information; and
outputting the first type of advertisement.

18. The method of claim 17, wherein the plurality of types of advertisements are produced to be different from each other, based on at least one of a category to which the content belongs, age information, and gender information.

19. The method of claim 17, wherein selecting the first type of advertisement comprises:
determining content that is most frequently used by a user of the electronic device, based on the first usage history information; and
selecting, as the first type of advertisement, a type of advertisement that corresponds to a category of the most frequently used content.

20. The method of claim 19, wherein receiving the first usage history information further comprises receiving the first user information.

21. The method of claim 20, wherein in selecting the first type of advertisement, if there are a plurality of types of advertisements that correspond to the category of the most frequently used content, the first type of advertisement is selected based on at least one of age information and gender information, which are included in the first user information.

22. The method of claim 17, further comprising, if the first usage history information is not received, receiving at least one of age information and gender information, which are extracted from the first voice input.

23. The method of claim 22, wherein the first type of advertisement is selected based on at least one of the age information and the gender information.

24. The method of claim 17, further comprising:
selecting one or more second advertisements that are related to the first advertisement based on the first usage history information; and
outputting the one or more second advertisements.

25. A server for providing advertisements to an electronic device, the server comprising:
a communication module that receives a request for the first advertisement from a first voice input received from the electronic device, and receives first usage history information that corresponds to first user information that is identified through the first voice input; and
a controller that selects a first type of advertisement from among a plurality of types of advertisements that correspond to the first advertisement, based on the first usage history information, and outputs the first type of advertisement through the communication module.

26. The server of claim 25, wherein the plurality of types of advertisements are produced to be different from each other, based on at least one of a category to which the content belongs, age information, and gender information.

27. The server of claim 25, wherein the controller determines content that is most frequently used by a user of the electronic device, based on the first usage history information, and selects, as the first type of advertisement, a type of advertisement that corresponds to a category of the most frequently used content.

28. The server of claim 27, wherein the communication module further receives the first user information.

29. The server of claim 28, wherein if there are a plurality of types of advertisements that correspond to the category of the most frequently used content, the controller selects the first type of advertisement based on at least one of age information and gender information, which are included in the first user information.

30. The server of claim 25, wherein if the first usage history information is not received, the communication module receives at least one of age information and gender information, which are extracted from the first voice input.

31. The server of claim 30, wherein the controller selects the first type of advertisement based on at least one of the age information and the gender information.

32. The server of claim 25, wherein the controller selects one or more second advertisements that are related to the first advertisement based on the first usage history information, and controls the communication module to output the one or more second advertisements.
